(19) United States
(12) Patent Application Publication
(10) Pub. No.: US 2006/0085499 A1
(43) Pub. Date: Apr. 20, 2006

(54) User customizable mobile phone

(76) Inventor: Xiongwei Zhu, Shanghai (CN)

Correspondence Address: PERKINS COIE LLP;PATENT-SEA, P.O. BOX 1247, SEATTLE, WA, 98111-1247, US

(21) Appl. No.: 10/967,026

(22) Filed: Oct. 14, 2004

(51) Int. Cl. G06F 15/16

(52) U.S. Cl. 709/203

(57) ABSTRACT

A system and method is provided for efficiently modifying or changing resource files in a mobile phone. The resource files, such as ring tone, font, and wallpaper files, are preferably stored in one or more memory segments, which are separate from one or more code file memory segments, of the phone's nonvolatile, or flash, memory. A resource file management program is used to read, write, modify, and/or erase resource files separately from the code files and other files stored in the phone's nonvolatile memory. Accordingly, resource files can be written or otherwise delivered into the nonvolatile memory of the phone without the need to re-download, rewrite, or otherwise update the code files and other non-resource files stored in the phone's nonvolatile memory.

### BACKGROUND

Mobile phones typically include resource files, such as ring tone, font, and background “wallpaper” files, stored in memory segments in the phones. Resource files are commonly stored within a software array in a phone. After the array is compiled by the phone's compiler, the array is generally stored in a code file segment of the phone's memory. In many mobile phones, the resource files are stored in a nonvolatile memory, such as a flash memory, of the phones.

In some mobile phones, one or more of the resource files stored in the phones are at least partially modifiable by a user. When a user modifies a resource file, by downloading a new ring tone from the Internet, for example, the code files stored in the phone's memory typically must be re-downloaded to enable use of the new resource file. As a result, modifying or changing resource files in a mobile phone is often a cumbersome, time-consuming, process. Thus, a need exists for a more efficient system and method for modifying or changing resource files stored in a mobile phone.

### SUMMARY OF THE INVENTION

The invention is directed to systems and methods for efficiently modifying or changing resource files in a mobile phone. The resource files, such as ring tone, font, and wallpaper files, are preferably stored in one or more memory segments, which are separate from one or more code file memory segments, of the phone's nonvolatile, or flash, memory. A resource file management program is used to read, write, modify, and/or erase resource files separately from the code files and other files stored in the phone's nonvolatile memory. Accordingly, resource files can be written or otherwise delivered into the nonvolatile memory of the phone without the need to re-download the code files, and/or other files, stored in the phone's nonvolatile memory.

In one aspect, a method for customizing features in a phone includes accessing a resource file management program in a computer, and connecting the phone to the computer. The phone includes a nonvolatile memory having a resource file memory segment and a separate code file memory segment. The method further includes identifying, via the resource file management program, a first resource file stored in the resource file memory segment. The resource file management program removes the first resource file from the resource file memory segment of the phone, and writes a second resource file into the resource file memory segment.

In another aspect, after removing the first resource file, the resource file management program modifies the first resource file via an editing feature of the resource file management program. The resource file management program then writes the modified resource file into the resource file memory segment of the phone.

In another aspect, a method for customizing features in a phone includes accessing a resource file management program in a computer, and connecting the phone to the computer. The phone includes a nonvolatile memory having a resource file memory segment and a separate code file memory segment. The method further includes writing, via the resource file management program, a resource file into the resource file memory segment, and restarting the phone to enable the resource file.

In another aspect, the writing step in one or more of the above methods does not include writing or downloading a code file.

In another aspect, a user-customizable mobile phone includes means for connecting the phone to a computer including a resource file management program. The phone further includes a nonvolatile memory including a resource file memory segment, and a code file memory segment separate from the resource file memory segment. The phone also includes a compiler for compiling resource files into the resource file memory segment, and for generating MAP files indicating at least one of a number, a location, and a size of the resource files in the resource file memory segment.

In another aspect, a system for customizing features in a mobile phone includes a phone and a computer. The phone has a nonvolatile memory including a resource file memory segment, and a code file memory segment separate from the resource file memory segment. The phone further includes a compiler for compiling resource files into the resource file memory segment, and for generating MAP files indicating at least one of a number, a location, and a size of the resource files in the resource file memory segment. The computer is connectable to the phone, and includes a resource file management program. The resource file management program includes means for removing existing resource files from the resource file memory segment of the phone, and means for writing new and/or modified resource files into the resource file memory segment of the phone.

Other features and advantages of the invention will appear hereinafter. The features of the invention described above can be used separately or together, or in various combinations of one or more of them. The invention resides as well in sub-combinations of the features described.

### BRIEF DESCRIPTION OF THE DRAWINGS

FIG. 1 is a schematic diagram of a mobile phone connected to a personal computer including resource file management software.

FIG. 2 is a flow diagram of a method for changing a resource file in a mobile phone according to one preferred embodiment.

### DETAILED DESCRIPTION OF THE DRAWINGS

The methods and features described herein may be implemented in any mobile telephone, such as a cellular phone, or in any other telephone that includes a processor, a compiler, and nonvolatile memory storage, such as flash memory. Flash memory is a type of electrically erasable programmable read-only memory (EEPROM), in which a section of memory cells can typically be erased in a single action, or in a “flash.” Flash memory can be written in blocks, rather than bytes, which makes it relatively easy to update.

A key feature of flash memory is that it retains its data when the device in which it is contained is powered off. Additionally, a flash memory chip, for example, can be electrically erased and reprogrammed without being removed from the circuit board on which it resides. In the mobile phones described herein, nonvolatile memory is preferably embodied in a flash memory card or chip that is insertable into a phone. The nonvolatile memory may alternatively be provided in the phone in or on any other suitable medium.

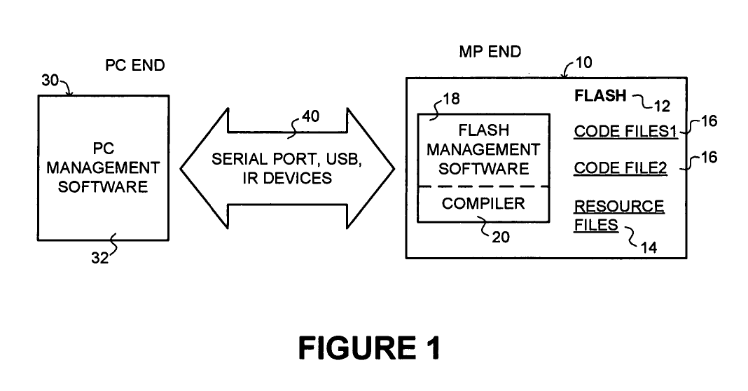

As shown in FIG. 1, the nonvolatile, or flash, memory 12 in a mobile phone 10 is preferably divided into individual segments for separately storing resource files 14, code files 16, and/or any other suitable files. For example, a 64 Mbit flash memory may be divided into four segments, each including 16 Mbits of memory. Alternatively, a 64 Mbit flash memory may be divided into two segments each including 8 Mbits of memory, and two segments each including 24 Mbits of memory, for accommodating larger and/or more numerous file types. Essentially, a flash memory 12 of any size may be divided into any number of segments, which may be of any size, and which may each be of the same or different sizes.

Each segment of the flash memory 12 can preferably be separately read, written, and erased, so that resource files 14 can be managed separately from code files 16 and other files stored in the flash memory 12. The mobile phone 10 preferably includes a flash memory management program 18, embodied in software or hardware in the phone 10, for facilitating the separate management of the various segments of the flash memory 12.

A compiler 20, which may be part of, or may work in conjunction with, the flash management program 18, preferably compiles resource files 14 into one or more designated segments of the flash memory 12. The compiler 20 also preferably generates MAP files indicating the location, number, and/or size of the resource files 14 stored in the memory segments. For example, the compiler 20 may generate a MAP file indicating that a first 10-bit ring tone file is stored in a first location of a first segment of the flash memory 12, and that a second 12-bit ring tone file is stored in a second location of the first segment of the flash memory 12.

The mobile phone 10 may initially include one or more pre-programmed resource files 14, stored in the nonvolatile, or flash, memory 12 of the phone, including ring tone files, font files, background “wallpaper” files, and/or any other files related to the sounds and visual effects produced by the phone 10. At initial startup, default resource files 14 are preferably enabled in the phone 10. Alternatively, a user may be required to select which resource files 14 to enable at the phone's initial startup.

The mobile phone 10 may include, for example, one or more user-selectable ring tones, such as a conventional ring sound, a classical music theme, etc., stored in the phone's flash memory 12 at initial startup. The phone 10 may also include a collection of user-selectable fonts, stored in the flash memory 12, in which characters, such as letters and numbers, can be displayed on the phone's display screen, and/or sent as text messages. Additionally, various wallpaper or screensaver images may be stored in the flash memory 12 of the phone 10 for selection by the user. Other aural tones, visual images, and/or other suitable resource files 14 may also be stored in the flash memory 12 of the phone 10.

A resource file management program 32 is preferably included with the mobile phone 10. The resource file management program 32 is preferably embodied in software that may be downloaded onto a personal computer 30 or other suitable computing system. For example, the resource file management program 32 may be embodied in a compact disc or other suitable storage medium, from which it may be downloaded onto a user's personal computer 30. Alternatively, the resource file management program 32 may be downloadable from the Internet, or from another suitable source. In the case where the resource file management program 32 is downloaded from the Internet, a password, which is preferably obtained when a user purchases the phone 10, may be required to obtain access to download the program.

The mobile phone 10 is preferably connectable to the computer 30 via any suitable connecting device 40, such as a USB cable or another cable adapted to engage a serial port in the computer 30, or via an infrared ray device. Once the mobile phone 10 is connected to a computer containing the resource file management program 32, a user can manage, change, or modify the resource files stored in the nonvolatile, or flash, memory 12 of the phone 10, as described in detail below.

The resource file management program 32 preferably includes a graphical user interface (“GUI”) for facilitating resource file management by the user. The GUI preferably allows the user to “drag and drop” resource files to and from the mobile phone's flash memory 12, via a mouse, a keyboard, or another suitable computer accessory. Alternatively, the resource file management program 32 may be controllable via a series of keyboard commands and/or on-screen menus displayed on the computer's monitor, or via any other suitable mechanism.

The resource file management program 32 preferably includes a database containing a variety of resource files that a user may select to download into the flash memory 12 of the mobile phone 10. For example, the resource file management program 32 may include a database containing a variety of ring tone files, wallpaper and screensaver files, font files, and/or any other suitable resource files for selection by a user. Alternatively, or additionally, the resource file management program 32 may include functionality allowing a user to select resource files from other locations, such as from web sites resident on the Internet, etc. In such a case, resource files may be copied from their resident locations and saved in the resource file management program's database, and/or the resource file management program may facilitate direct downloading of the resource files from their resident locations into the phone's flash memory.

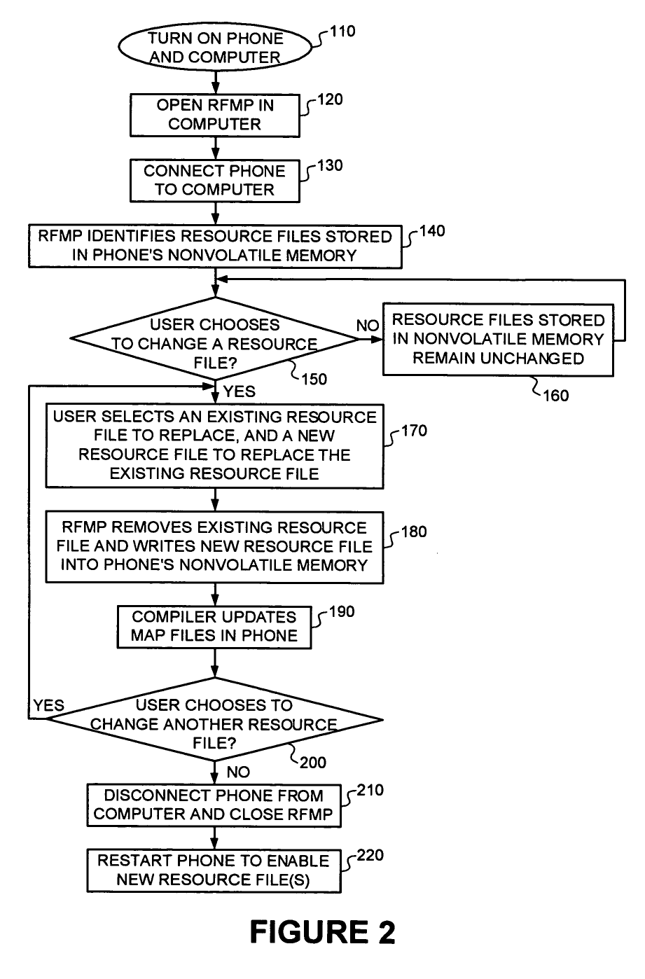

FIG. 2 is a flow diagram illustrating one preferred method for changing or modifying one or more resource files in a mobile phone. At step 110, the user turns on the phone and the computer into which the resource file management program was previously downloaded. If the resource file management program is not yet downloaded to the computer, the user must first download the resource file management program to the computer before changing or modifying any resource files stored in the phone. At step 120, the user opens the resource file management program, by, for example, double-clicking on a resource file management program icon on the computer's desktop, or selecting the resource file management program from an on-screen menu, preferably using a mouse, a keyboard, or another suitable computer accessory.

At step 130, the user connects the phone to the computer. The phone may be connected to the computer with a USB cable, another cable adapted to engage a serial port in the computer's processor, an infrared ray device, or another suitable connecting device. At step 140, the resource file management program identifies the one or more resource files stored in the nonvolatile, or flash, memory of the phone. The resource file management program preferably identifies the number of resource files stored in the flash memory, as well as the specific location and size of each of the resource files, via MAP files generated by the phone's compiler.

At step 150, the user decides whether to change or modify one or more resource files stored in the flash memory of the phone. If the user does not choose to change or modify any resource files, then the resource files stored in the flash memory remain unchanged, as shown at step 160. If the user chooses to change or modify one or more resource files, the user selects a first resource file to change, for example, a ring tone file stored in the flash memory, and further selects a resource file with which to replace the first resource file, as shown at step 170.

In one preferred method, the user is able to “drag and drop,” via a GUI in the resource file management program, the selected resource file from the resource file database (or from another location, as described above) in the resource file management program into the nonvolatile, or flash, memory of the phone. Alternatively, the user may change a resource file via programming commands, on-screen menus, and/or any other suitable user interface. At step 180, in one preferred embodiment, when the user drags the selected resource file into the phone's flash memory (which may be represented by an on-screen icon, menu, or other symbol), the resource file management program deletes, erases, or otherwise removes the first resource file from the flash memory. The resource file management program then writes or otherwise delivers the selected resource file into the flash memory. The user may alternatively separately drag the first resource file into a deleted items folder, or a “trash” or “recycle” bin, displayed on the GUI, and then drag the selected resource file into the phone's flash memory.

The phone's compiler preferably compiles the selected resource file into the resource file segment of the phone's flash memory, and updates the MAP files to indicate the location and/or size of the selected resource file, as shown at step 190. Alternatively, the resource file management program may automatically direct the selected resource file into the former location of the removed resource file via information provided by the MAP files generated by the compiler. At this point, the resource file has been changed in the flash memory of the phone. All of the above steps are preferably performed without re-downloading or re-writing code files, or other non-resource files, stored in the phone's flash memory. Accordingly, the resource file is changed or modified in a very efficient manner.

At step 200, the user decides whether to change or modify another resource file. If the user chooses to change another resource file, the process returns to step 170, where the user selects which resource file to remove and which resource file to add. If the user chooses not to change another resource file, the user may then disconnect the phone from the computer and close the resource file management program in the computer, as shown at step 210. The user then preferably restarts the phone to enable the one or more new resource files stored in the flash memory of the phone, as shown at step 220.

In another preferred embodiment, the user may add new resource files to, or remove resources from, the flash memory of the phone without replacing any resource files. In other words, the user may store multiple resource files of a given type, for example, ring tone files, in the phone's flash memory at any given time. In such a case, the phone preferably includes an on-screen menu, or another suitable user interface, allowing the user to select which resource file to enable at any given time. In this embodiment, when the user drags the new resource file into the flash memory of the phone, an existing resource file is not automatically deleted, erased, or otherwise removed. To remove a resource file from the flash memory, therefore, the user may, for example, drag the resource file to be removed from the phone's flash memory into the deleted items folder, or trash or recycle bin. The resource file may alternatively be deleted via programming commands, menu selections, or in any other suitable manner.

In another preferred embodiment, the user may use the resource file management program to modify existing resource files stored in the flash memory of the phone without replacing the existing resource files with separate resource files. In other words, a user may use the resource file management program to select a resource file stored in the phone's flash memory, and to modify portions of that resource file. The user may, for example, select an existing ring tone file, and then delete portions of the ring tone file using a resource file editing feature included in the resource file management program. Alternatively, the user may add sounds or segments of music stored in a database in the resource file management program, or from another source, such as the Internet, to the existing ring tone file. For example, the user may add a bird call sound to a conventional ring tone file. Wallpaper files, font files, and any other resource files stored in the phone's nonvolatile, or flash, memory may be modified in a similar manner using the editing feature of the resource file management program.

The systems and methods described herein for customizing features of a mobile phone provide the advantage of efficiently changing or modifying resource files in a mobile phone without the need to re-download, rewrite, or otherwise update code files, and other non-resource files, stored in the phone's nonvolatile, or flash, memory. Accordingly, resource files stored in the nonvolatile memory of the phone can be changed or modified in a very efficient manner.

While embodiments and applications of the present invention have been shown and described, it will be apparent to one skilled in the art that other modifications are possible without departing from the inventive concepts herein. Importantly, many of the steps detailed above may be performed in a different order than that which is described. For example, in practice, the phone may be connected to the computer (step 30 in FIG. 2) before the resource file management program is opened in the computer (step 20 in FIG. 2). The invention, therefore, is not to be restricted except by the following claims and their equivalents.

What is claimed is:

1. A method for customizing features in a phone, comprising the steps of:
accessing a resource file management program in a computer;
connecting the phone to the computer, wherein the phone includes a nonvolatile memory having a resource file memory segment and a separate code file memory segment;
identifying, via the resource file management program, a first resource file stored in the resource file memory segment;
removing, via the resource file management program, the first resource file from the resource file memory segment; and
writing, via the resource file management program, a second resource file into the resource file memory segment.

2. The method of claim 1 wherein the writing step is initiated by a user dragging and dropping the second resource file, via a graphical user interface, from a database in the resource file management program into the resource file memory segment.

3. The method of claim 1 wherein the connecting step comprises connecting the phone to the computer via a USB cable.

4. The method of claim 1 further comprising the step of restarting the phone, after the writing step, to enable the second resource file.

5. The method of claim 4 wherein the writing and restarting steps do not include writing or downloading a code file.

6. The method of claim 1 wherein the removing step comprises erasing the first resource file from the first memory segment.

7. The method of claim 1 wherein the first and second resource files each comprise at least one of a ring tone file, a wallpaper file, and a font file.

8. The method of claim 1 wherein the identifying step comprises locating the first resource file via a MAP file generated by a compiler in the phone.

9. A method for customizing features in a phone, comprising the steps of:
accessing a resource file management program in a computer;
connecting the phone to the computer, wherein the phone includes a nonvolatile memory having a resource file memory segment and a separate code file memory segment;
writing, via the resource file management program, a resource file into the resource file memory segment; and
restarting the phone to enable the resource file.

10. The method of claim 9 wherein the writing and restarting steps do not include writing or downloading a code file.

11. The method of claim 9 wherein the resource file comprises one of a ring tone file, a wallpaper file, and a font file.

12. A method for customizing features in a phone, comprising the steps of:
accessing a resource file management program in a computer;
connecting the phone to the computer, wherein the phone includes a nonvolatile memory having a resource file memory segment and a separate code file memory segment;
removing, via the resource file management program, a first resource file from the resource file memory segment;
modifying, via an editing feature of the resource file management program, the first resource file into a modified resource file; and
writing, via the resource file management program, the modified resource file into the resource file memory segment.

13. The method of claim 12 further comprising the step of restarting the phone, after the writing step, to enable the modified resource file.

14. The method of claim 13 wherein the writing and restarting steps do not include downloading a code file.

15. The method of claim 12 wherein the first resource file comprises one of a ring tone file, a wallpaper file, and a font file.

16. The method of claim 12 further comprising the step of locating the first resource file in the resource file memory segment via a MAP file generated by a compiler in the phone.

17. A user-customizable mobile phone, comprising:
means for connecting the phone to a computer including a resource file management program;
a nonvolatile memory including:
a resource file memory segment; and
a code file memory segment separate from the resource file memory segment; and
a compiler for compiling resource files into the resource file memory segment, and for generating MAP files indicating at least one of a number, a location, and a size of the resource files in the resource file memory segment.

18. A system for customizing features in a mobile phone, comprising:
a phone comprising:
a nonvolatile memory including:
a resource file memory segment; and
a code file memory segment separate from the resource file memory segment; and
a compiler for compiling resource files into the resource file memory segment, and for generating MAP files indicating at least one of a number, a location, and a size of the resource files in the resource file memory segment;
a computer that is connectable to the phone, the computer including a resource file management program comprising:
means for removing existing resource files from the resource file memory segment of the phone; and
means for writing at least one of new and modified resource files into the resource file memory segment of the phone.

19. The system of claim 18 wherein the means for removing and writing resource files are accessible by a user via a graphical user interface.

20. The system of claim 18 wherein each of the resource files in the resource file memory segment comprises one of a ring tone file, a wallpaper file, and a font file.

21. The system of claim 18 wherein the means for removing and writing resource files perform the steps of writing and removing without downloading or writing a code file.

22. The system of claim 18 wherein the resource file management program further comprises a database containing a variety of resource files that are downloadable into the phone via the resource file management program.
